(19) United States
(12) Patent Application Publication
(10) Pub. No.: US 2010/0021779 A1
(43) Pub. Date: Jan. 28, 2010

(54) SOLID OXIDE FUEL CELL SYSTEM INTEGRATED WITH REFORMER

(75) Inventors: Joongmyeon Bae, Daejeon (KR); Kwang-Jin Park, Seoul (KR); Gyujong Bae, Daejeon (KR); Changbo Lee, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: KOREA ADVANCD INSTITUTE OF SCIENCE AND TECHNOLOGY, Daejeon (KR)

(21) Appl. No.: 12/510,455

(22) Filed: Jul. 28, 2009

(30) Foreign Application Priority Data
Jul. 28, 2008 (KR) 10-2008-0073354

(51) Int. Cl. H01M 8/18

(52) U.S. Cl. 429/19

(57) ABSTRACT

The present invention relates to a solid oxide fuel cell, in which an external reformer is integrated with a solid oxide fuel cell stack, thereby efficiently controlling heat and simplifying a system structure thereof.

### TECHNICAL FIELD

The present invention relates to a solid oxide fuel cell, in which an external reformer is integrated with a solid oxide fuel cell stack, thereby efficiently controlling heat and simplifying a system structure thereof.

### BACKGROUND ART

A fuel cell is known as an ideal energy converting device that is most efficient to produce electricity using hydrogen, and it will be a critical technology in future society. Meanwhile, even in the present that fossil fuel is sued as an energy source, the fuel cell as an efficient and clean energy converting device can be applied in various fields, and researches for commercializing the fuel cell used in energy saving and other special functions are actively going on in many countries of the world. The fuel cell is generally classified into five sorts, and among them, a solid oxide fuel cell (SOFC) and a polymer electrolyte membrane fuel cell (PEMFC) having a solid-phase electrolyte are widely studied recently. The development of a fuel cell system for domestic distributed power generation is also centered around the above two kinds of fuel cells. The PEMFC operated at a relatively low temperature of 80° C. has the advantage of easy formation of a stack and a small size. The SOFC has high efficiency and high waste heat and thus it is more suitable for cogeneration, and since it was verified that a unit cell thereof had a life span of 60,000, it has also an excellent property in the economic aspect. Further, since the SOFC has a high operation temperature, it can use as fuel carbon monoxide as well as hydrogen and also relatively facilely realize a system including a hydrocarbon fuel reformer.

In the present time that an infrastructure for producing and supplying hydrogen used for the fuel cell is unsatisfactory and the hydrogen is mainly produced by reforming the existing fossil fuel, not by renewable energy, a reforming system for converting the fossil fuel into the hydrogen is necessarily needed. In the field of automobile, it seems that the hydrogen will be mass-produced in a hydrogen station and then supplied and stored in a vehicle. However, in a distributed cogeneration system, a reformer has to be included in the generation system in order to utilize the high efficiency and high water heat. Particularly, it is preferable that a distributed power source in a remote country place, where it is difficult to build a fuel supply line, uses diesel, kerosene, LPG and the like as an energy source. Therefore, it is necessary to develop a reformer for these fuels. A fuel reforming system is roughly divided into a reformer, a desulfurizing device and a process for removing carbon monoxide. In the SOFC as described above, since the carbon monoxide can be used as fuel in the stack thereof, the process for removing carbon monoxide does not need. FIG. 10 schematically shows a general reforming system for the SOFC.

The reformer is a main part of the reforming system, in which the fuel is converted by chemical reaction to syn-gas having hydrogen as a main element. In general, the SOFC system can be classified into an internal reforming SOFC and an external reforming SOFC according to types of reformer. The internal reforming SOFC has high efficiency and simple structure comparing with the external reforming SOFC, but it is difficult to stably operate it due to difficulty in controlling the system. The external reforming SOFC has slightly low efficiency, but it can be stably operated since each part can be controlled separately. However, since it is necessary to separately perform heat management in all of the reformer and the SOFC stack, the system has a very complicated structure.

The SOFC has a high operation temperature of 600˜1000° C. A direct internal reforming method of hydrocarbon using the high operation temperature has been already studied in the field of SOFC. However, there has not yet proposed a direct internal reforming method of hydrocarbon using a metal supported SOFC and a catalyst layer.

### DISCLOSURE OF THE INVENTION

It is an object of the present invention to provide a solid oxide fuel cell system integrated with a reformer, in which a catalyst layer for a direct internal reforming process used in an existing SOFC is applied to a metal supported SOFC.

To achieve the above object, the present invention provides a solid oxide fuel cell system integrated with reformer, comprising a unit cell 100 having an electrolyte layer 110, an anode 120 coupled to a lower surface of the electrolyte layer 110 and a cathode 130 coupled to an upper surface of the electrolyte layer 110; a middle anode separator 200 formed with a fuel gas supplying hole 212, a fuel gas discharging hole 214, an air supplying hole 222 and an air discharging hole 224 that pass through the middle anode separator 200, and also formed with a fuel channel 232 connected to the fuel gas supplying hole 212 and the fuel gas discharging hole 214, which is formed at an upper surface of the middle anode separator 200; a middle cathode separator 300 formed with a fuel gas supplying hole 312, a fuel gas discharging hole 314, an air supplying hole 322 and an air discharging hole 324 that pass through the middle cathode separator 300, and also formed with an air channel 332 connected to the air supplying hole 322 and the air discharging hole 324, which is formed at a lower surface of the middle cathode separator 300; a lowermost anode separator 400 formed with a fuel gas supplying groove 412, a fuel gas discharging groove 414, an air supplying groove 422, an air discharging groove 424, a fuel channel 432 connected with the fuel gas supplying groove 412 and the fuel gas discharging groove 414, a first anode reformer installing groove 442 communicated with the first cathode reformer installing hole 342 so as to install a reformer, and a first anode burner installing groove 452 communicated with the first cathode burner installing hole 352 so as to install an after burner, which are formed at an upper surface of the lowermost anode separator 400, and also formed with a fuel gas supply communication hole 462 communicating the first anode reformer installing groove 442 and the fuel gas supplying groove 412; and an uppermost cathode separator 500 formed with a fuel gas supplying groove 512, a fuel gas discharging groove 514, an air supplying groove 522, an air discharging groove 524, an air channel 532 connected with the fuel gas supplying groove 512 and the fuel gas discharging groove 514, a first cathode reformer installing groove 542 communicated with the first anode reformer installing hole 242 so as to install the reformer, and a first cathode burner installing groove 552 communicated with the first anode burner installing hole 252 so as to install the after burner, which are formed at a lower surface of the uppermost cathode separator 500, and also formed with a first air discharge communication hole 572 communicating the air discharging groove 524 and the first cathode burner installing groove 552, wherein the middle anode separator 200 is formed with a first anode reformer installing hole 242 for installing the reformer, and a first anode burner installing hole 252 for installing the after burner, which pass through the middle anode separator 200, and the middle cathode separator 300 is formed with a first cathode reformer installing hole 342 communicated with the first anode reformer installing hole 242 so as to install the reformer, and a first cathode burner installing hole 352 communicated with the first anode reformer installing hole 242 so as to install the after burner, which pass through the middle cathode separator 300.

Preferably, the middle anode separator 200 is formed with a second anode reformer installing hole 244 for installing the reformer and a second anode burner installing hole 254 for installing the after burner, which pass through the middle anode separator 200, and the middle cathode separator 300 is formed with a cathode reformer installing hole 344 communicated with the second anode reformer installing hole 244 so as to install the reformer and a second cathode burner installing hole 354 communicated with the second anode reformer installing hole 244 so as to install the after burner, which pass through the middle cathode separator 300, and the lowermost anode separator 400 is formed with a second anode reformer installing groove 444 communicated with the second cathode reformer installing hole 344 so as to installing the reformer and a second anode burner installing groove 454 communicated with the second cathode burner installing hole 354 so as to installing the after burner, which are formed at an upper surface of the lowermost anode separator 400, and the uppermost cathode separator 500 is formed with a second cathode reformer installing groove 544 communicated with the second anode reformer installing hole 244 so as to installing the reformer and a second cathode burner installing groove 554 communicated with the second anode burner installing hole 254 so as to installing the after burner, which are formed at an upper surface of the uppermost cathode separator 500, and also formed with a reformer installing groove communication hole 582 communicating the second cathode reformer installing groove 544 and the first cathode reformer installing groove 542, a second fuel gas discharge communication hole 564 communicating the fuel gas discharging groove 514 and the second cathode burner installing groove 554 and a second air discharge communication hole 574 communicating the air discharging groove 524 and the second cathode burner installing groove 554.

Preferably, an air injecting hole 472 communicated with the air supplying groove 422, a fuel gas injecting hole 482 communicated with the second anode reformer installing groove 444, a first burned gas discharging hole 492 communicated with the first anode burner installing groove 452 and a second burned gas discharging hole 494 communicated with the second anode burner installing groove 454 are formed at a side surface of the lowermost anode separator 400.

Preferably, the air supplying groove 422 is opposed to the second anode reformer installing groove 444, the first anode burner installing groove 452 is opposed to the second anode burner installing groove 454, the air supplying groove 422 is opposed to the air discharging groove 424 and the fuel gas supplying groove 412 is opposed to the fuel gas discharging groove 414 with the fuel channel 432 in the center, and the air supplying groove 422 has a deeper depth than the first anode reformer installing groove 442 so that the air injecting hole 472 is spaced apart to a lower side of the first anode reformer installing groove 442 so as to be communicated with a lower end of the first anode reformer installing groove 442.

Preferably, the fuel gas discharging groove 514 and the first cathode burner installing groove 552 have a deeper depth than the fuel gas supplying groove 512 so that the fuel gas supply communication hole 562 is spaced apart to an upper side of the fuel gas supplying groove 512 so as to be communicated with an upper end of the fuel gas discharging groove 514 and an upper end of the first cathode burner installing groove 552, and the first cathode reformer installing groove 542 and the second cathode reformer installing groove 544 have a deeper depth than the air supplying groove 522 and the air discharging groove 524 so that the reformer installing groove communication hole 582 is spaced apart to an upper side of the air supplying groove 522 and the air discharging groove 524 so as to be communicated with an upper end of the first cathode reformer installing groove 542 and an upper end of the second cathode reformer installing groove 544.

Preferably, a metal support is stacked on a lower surface of the unit cell 100 and an anode current collector is stacked on an upper surface thereof. Alternatively, an anode current collector is stacked on a lower surface of the unit cell 100, and a cathode current collector is stacked on an upper surface thereof.

Also, the present invention provides a solid oxide fuel cell system integrated with reformer, comprising a unit cell 100 having an electrolyte layer 110, an anode 120 coupled to a lower surface of the electrolyte layer 110 and a cathode 130 coupled to an upper surface of the electrolyte layer 110; a middle anode separator 200 formed with a fuel gas supplying hole 212, a fuel gas discharging hole 214, an air supplying hole 222 and an air discharging hole 224 that pass through the middle anode separator 200, and also formed with a fuel channel 232 connected to the fuel gas supplying hole 212 and the fuel gas discharging hole 214, which is formed at an upper surface of the middle anode separator 200; a middle cathode separator 300 formed with a fuel gas supplying hole 312, a fuel gas discharging hole 314, an air supplying hole 322 and an air discharging hole 324 that pass through the middle cathode separator 300, and also formed with an air channel 332 connected to the air supplying hole 322 and the air discharging hole 324, which is formed at a lower surface of the middle cathode separator 300, wherein the middle anode separator 200 is formed with a first anode reformer installing hole 242 for installing a reformer, and a first anode burner installing hole 252 for installing an after burner, which pass through the middle anode separator 200, and the middle cathode separator 300 is formed with a first cathode reformer installing hole 342 communicated with the first anode reformer installing hole 242 so as to install the reformer, and a first cathode burner installing hole 352 communicated with the first anode reformer installing hole 242 so as to install the after burner, which pass through the middle cathode separator 300.

### BRIEF DESCRIPTION OF THE DRAWINGS

FIG. 1 is an exploded perspective view of a first unit 1100 including a middle anode separator, a unit cell and a middle cathode separator according to a first embodiment of the present invention.

FIG. 2 is an exploded perspective view of a second unit 1200 including a lowermost anode separator, a unit cell and a middle cathode separator.

FIG. 3 is an exploded perspective view of a third unit 1300 including a middle anode separator, a unit cell and an uppermost cathode separator.

FIG. 4 is a perspective view of the middle anode separator 200 according to the first embodiment of the present invention.

FIG. 5a is a perspective view of the middle cathode separator 300.

FIG. 5b is a lower perspective view of the middle cathode separator 300.

FIG. 6 is a perspective view of the lowermost anode separator 400 according to the first embodiment of the present invention.

FIG. 7a is a schematic view of a main portion of the lowermost anode separator 400 of FIG. 6.

FIG. 7b is a schematic view of a fuel gas discharging groove 414 and a second anode burner installing groove 454 as viewed along an arrow B.

FIG. 7c is a schematic view of an air supplying groove 422 and a first anode reformer installing groove 442 as viewed along an arrow C.

FIG. 8a is a perspective view of the uppermost cathode separator 500 of FIG. 3.

FIG. 8b is a lower perspective view of the uppermost cathode separator 500 of FIG. 3.

FIG. 9 is a schematic view of a main portion of the uppermost cathode separator 500 of FIG. 8a.

FIG. 10 is a schematic view of a general reforming system for SOFC.

### DETAILED DESCRIPTION OF MAIN ELEMENTS

100: unit cell

110: electrolyte layer

120: anode

130: cathode

200: middle anode separator

212: fuel gas supplying hole

214: fuel gas discharging hole

222: air supplying hole

224: air discharging hole

232: fuel channel

242: first anode reformer installing hole

244: second anode reformer installing hole

252: first anode burner installing hole

254: second anode burner installing hole

300: anode separator

314: fuel gas discharging hole

322: air supplying hole

324: air discharging hole

332: air channel

342: first cathode reformer installing hole

344: second cathode reformer installing hole

352: first cathode burner installing hole

354: second cathode burner installing hole

400: lowermost anode separator

412: fuel gas supplying groove

414: fuel gas discharging groove

422: air supplying groove

424: air discharging groove

432: fuel channel

442: first anode reformer installing groove

444: second anode reformer installing groove

452: first anode burner installing groove

454: second anode burner installing groove

462: fuel gas supply communication hole

462: fuel gas supply communication hole

472: air injecting hole

482: fuel gas injecting hole

492: first burned gas discharging hole

494: second burned gas discharging hole

500: uppermost cathode separator

512: fuel gas supplying groove

514: fuel gas discharging groove

522: air supplying groove

524: air discharging groove

532: air channel

542: first cathode reformer installing groove

544: second cathode reformer installing groove

552: first cathode burner installing groove

554: second cathode burner installing groove

562: fuel gas supply communication hole

564: second fuel gas discharge communication hole

572: first air discharge communication hole

574: second air discharge communication hole

582: reformer installing groove communication hole

600: metal support

700: current collector

800: insulating member

810: through-hole

812: fuel gas supplying hole

814: fuel gas discharging hole

822: air supplying hole

824: air discharging hole

832: fuel channel

842: first insulating member reformer installing hole

844: second insulating member reformer installing hole

852: first insulating member burner installing hole

85: second insulating member burner installing hole

### BEST MODE FOR CARRYING OUT THE INVENTION

A solid oxide fuel cell (SOFC) system is formed by stacking a plurality of units including a cathode separator, a unit cell and an anode separator. In the present invention, since an anode separator stacked as a lowermost layer has a different structure from other anode separator stacked at an upper side thereof, the anode separator stacked as the lowermost layer is called a lowermost anode separator and the other anode separator stacked at the upper side of the lowermost anode separator is called a middle anode separator. In the same way, since a cathode separator stacked as an uppermost layer has a different structure from other cathode separator stacked at a lower side thereof, the cathode separator stacked as the uppermost layer is called an uppermost anode separator and the other cathode separator stacked at the lower side of the uppermost cathode separator is called a middle cathode separator.

Hereinafter, the present invention is described in detail with reference to drawings.

### First Embodiment

A first embodiment is related to a SOFC system integrated with a reformer according to the present invention.

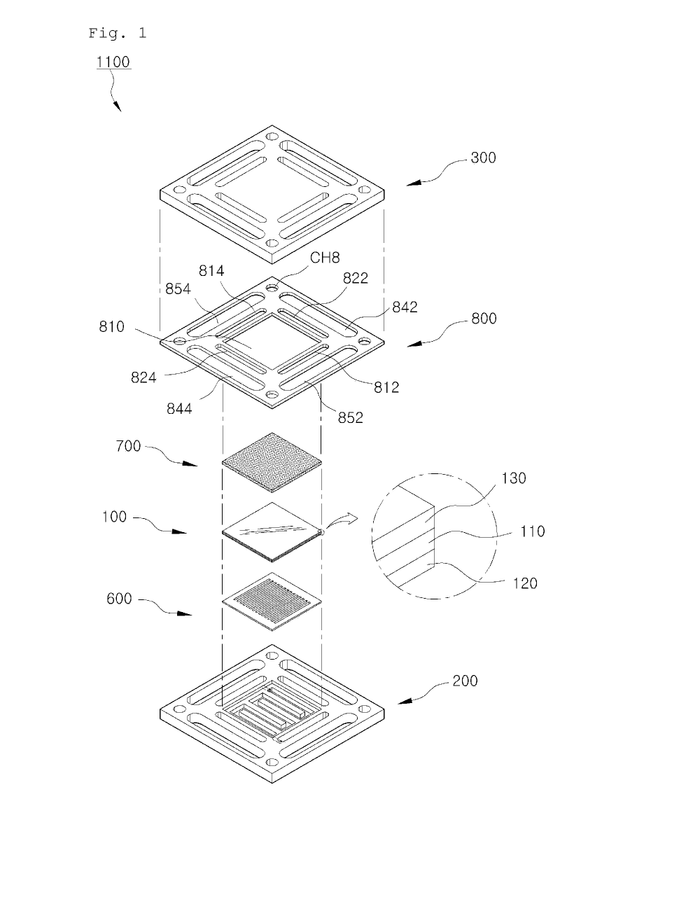

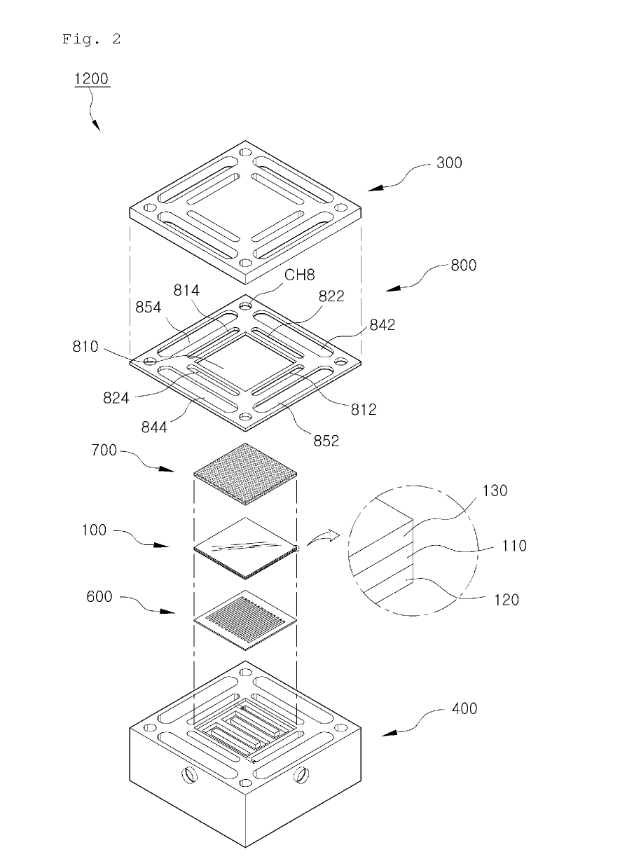

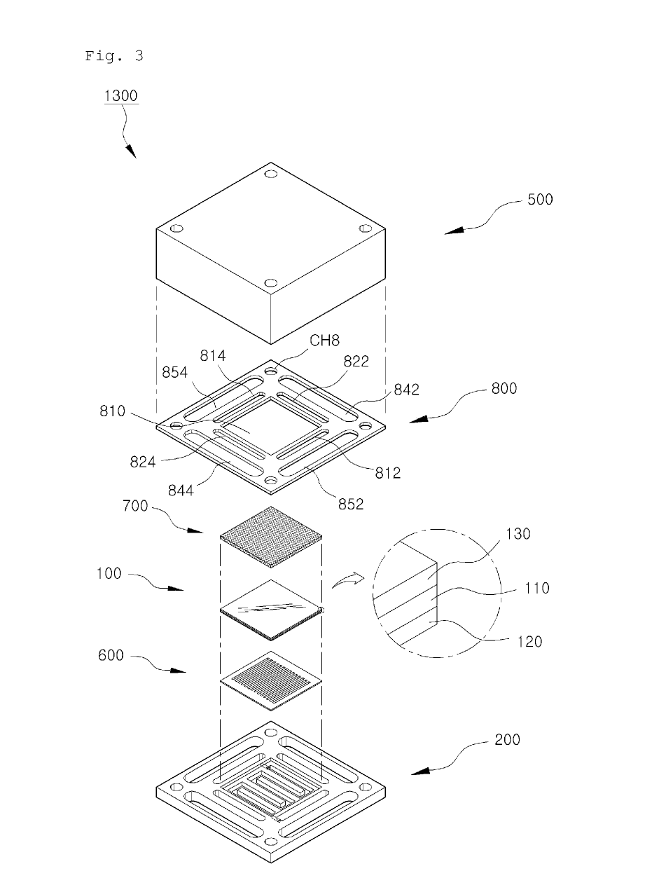

FIG. 1 is an exploded perspective view of a first unit 1100 including a middle anode separator, a unit cell and a middle cathode separator according to a first embodiment of the present invention, FIG. 2 is an exploded perspective view of a second unit 1200 including a lowermost anode separator, a unit cell and a middle cathode separator, and FIG. 3 is an exploded perspective view of a third unit 1300 including a middle anode separator, a unit cell and an uppermost cathode separator.

In the embodiment, the SOFC includes a second unit 1200, one or more first units 1100 and a third unit 1300 that are stacked in turn from a lower side to an upper side.

Referring to FIG. 1, the first unit 1100 includes a unit cell 100, a middle anode separator 200, a middle cathode separator 300, a metal support 600, a current collector 700 and an insulating member 800.

The unit cell 100 may be a general ceramic cell including an electrolyte layer 110, an anode 120 coupled to a lower surface of the electrolyte layer 110 and a cathode 130 coupled to an upper surface of the electrolyte layer 110.

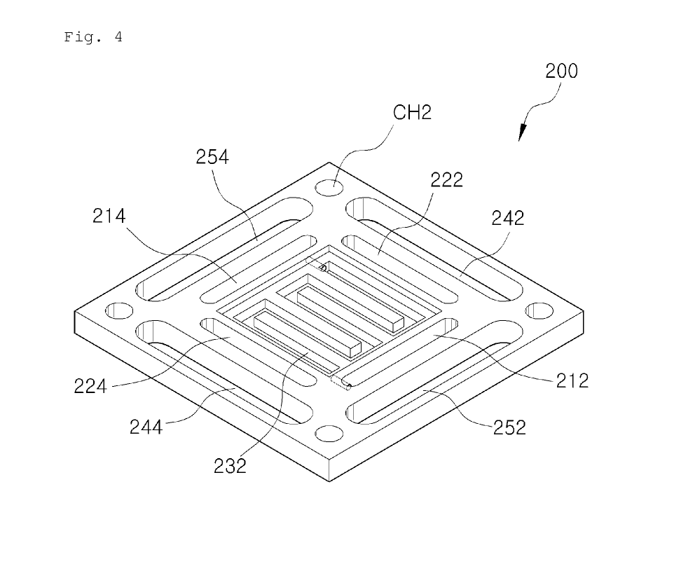

FIG. 4 is a perspective view of the middle anode separator 200 according to the first embodiment of the present invention.

Referring to FIG. 4, the middle anode separator 200 is formed with a fuel gas supplying hole 212, a fuel gas discharging hole 214, an air supplying hole 222 and an air discharging hole 224. Further, a fuel channel 232 communicated with the fuel gas supplying hole 212 and the fuel gas discharging hole 214 is formed in an upper surface of the middle anode separator 200. The fuel channel 232 is formed at a center portion of the middle anode separator 200 so that the fuel gas supplying hole 212 is opposed to the fuel gas discharging hole 214 and also the air supplying hole 222 is opposed to the air discharging hole 224 with the fuel channel 232 in the center.

Furthermore, the middle anode separator 200 is formed with a first anode reformer installing hole 242 for installing a first reformer (not shown), a second anode reformer installing hole 244 for installing a second reformer, a first anode burner installing hole 252 for installing a first after burner and a second anode burner installing hole 254 for installing a second after burner which are formed to pass through the middle anode separator 200. The first anode reformer installing hole 242 is opposed to the second anode reformer installing hole 244 and the first anode burner installing hole 252 is opposed to the second anode burner installing hole 254 with the fuel channel 232 in the center. The first anode reformer installing hole 242 is formed outside the air supplying hole 222, the second anode reformer installing hole 244 is formed outside the air discharging hole 224, the first anode burner installing hole 252 is formed outside the fuel gas supplying hole 212, and the second anode burner installing hole 254 is formed outside the fuel gas discharging hole 214.

Referring to FIG. 4, a coupling hole CH2 is formed to pass through the middle anode separator 200.

Referring to FIG. 1, a metal support 600 is stacked on the upper surface of the middle anode separator 200. An edge portion of the metal support 600 is attached to an edge portion of a fuel channel forming part.

Referring to FIG. 1, the unit cell 100 is attached to an upper surface of the metal support 600. The unit cell 100 is attached by slurry adhesion and the like so that the anode 120 is placed at a lower side of the unit cell 100.

The current collector 700 is stacked on an upper surface of the unit cell 100, and the middle cathode separator 300 is stacked on an upper surface of the current collector 700. Meanwhile, the insulating member 800 is stacked between the middle anode separator 200 and the middle cathode separator 300, and the insulating member 800 is formed with a through-hole 810 at a center portion thereof, through which the unit cell 100 and the current collector 700 are introduced.

Referring to FIG. 1, the insulating member 800 is also formed with a fuel gas supplying hole 812, a fuel gas discharging hole 814, an air supplying hole 822 and an air discharging hole 824 that pass through the insulating member 800. Also referring to FIG. 4, the fuel gas supplying hole 812 is disposed at an upper side of the fuel gas supplying hole 212 to be communicated with each other, the fuel gas discharging hole 814 is disposed at an upper side of the fuel gas discharging hole 214 to be communicated with each other, the air supplying hole 822 is disposed at an upper side of the air supplying hole 222 to be communicated with each other, and the air discharging hole 824 is disposed at an upper side of the air discharging hole 224 to be communicated with each other.

Referring to FIG. 1, the insulating member 800 is also formed with a first insulating member reformer installing hole 842, a second insulating member installing hole 844, a first insulating member burner installing hole 852 and a second insulating member burner installing hole 854 that pass through the insulating member 800. Also referring to FIG. 4, the first insulating member reformer installing hole 842 is disposed at an upper side of the first anode reformer installing hole 242 to be communicated with each other, the second insulating member reformer installing hole 844 is disposed at an upper side of the second anode reformer installing hole 244 to be communicated with each other, the first insulating member burner installing hole 852 is disposed at an upper side of the first anode burner installing hole 252 to be communicated with each other, and the second insulating member burner installing hole 854 is disposed at an upper side of the second anode burner installing hole 254 to be communicated with each other.

The insulating member 800 also has a coupling hole CH8.

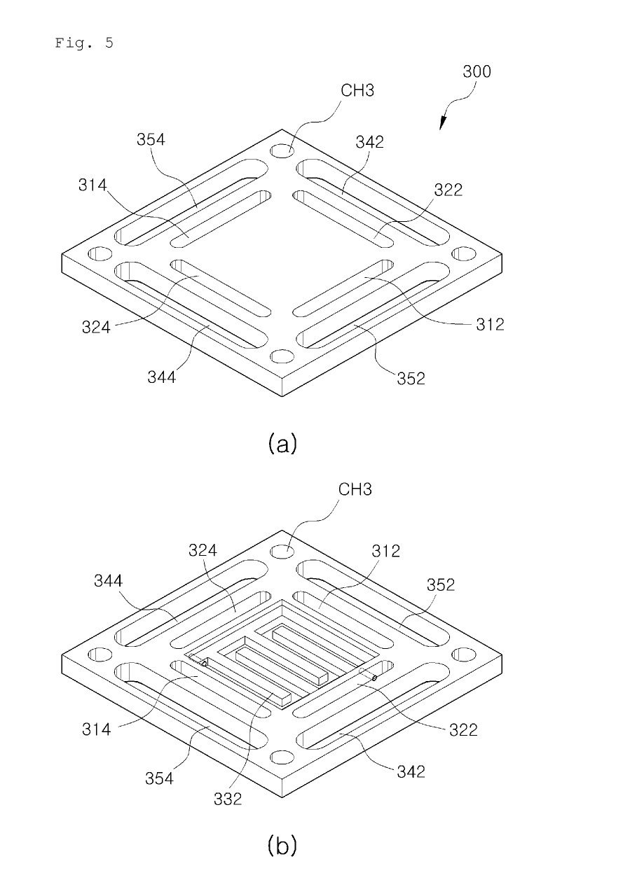

FIG. 5a is a perspective view of the middle cathode separator 300, and FIG. 5b is a lower perspective view of the middle cathode separator 300.

Referring to FIGS. 5a and 5b, the middle cathode separator 300 is formed with a fuel gas supplying hole 312, a fuel gas discharging hole 314, an air supplying hole 322 and an air discharging hole 324 that pass through the middle cathode separator 300. Also referring to FIG. 5b, an air channel 332 that are communicated with the air supplying hole 322 and the air discharging hole 324 is formed in a lower surface of the middle cathode separator 300. Referring to FIGS. 5a, 4 and 1, the fuel gas supplying hole 312 is disposed at an upper side of the fuel gas supplying hole 212 to be communicated with each other, the fuel gas discharging hole 314 is disposed at an upper side of the fuel gas discharging hole 214 to be communicated with each other, the air supplying hole 322 is disposed at an upper side of the air supplying hole 222 to be communicated with each other, and the air discharging hole 324 is disposed at an upper side of the air discharging hole 224 to be communicated with each other. Referring to FIGS. 5b and 1, the air channel 332 is formed at a center portion of the middle cathode separator 300 to be disposed at an upper side of the cathode 130 of the unit cell 100 via the current collector 700.

Referring to FIGS. 5a and 5b, the middle cathode separator 300 is also formed with a first cathode reformer installing hole 342, a second cathode reformer installing hole 344, a first cathode burner installing hole 352 and a second cathode burner installing hole 354 which are formed to pass through the middle cathode separator 300. Also referring to FIGS. 5a, 4 and 1, the first cathode reformer installing hole 342 is disposed at an upper side of the first anode reformer installing hole 242 to be communicated with each other through the insulating member 800, the second cathode reformer installing hole 344 is disposed at an upper side of the second anode reformer installing hole 244 to be communicated with each other through the insulating member 800, the first cathode burner installing hole 352 is disposed at an upper side of the first anode burner installing hole 252 to be communicated with each other through the insulating member 800, and the second cathode burner installing hole 354 is disposed at an upper side of the second anode burner installing hole 254 to be communicated with each other through the insulating member 800.

Referring to FIGS. 5a and 5b, a coupling hole CH3 is formed to pass through the middle cathode separator 300.

Referring to FIG. 2, the second unit 1200 includes a unit cell 100, a lower most anode separator 400, a middle cathode separator 300, a metal support 600, a current collector 700 and an insulating member 800.

Referring to FIG. 1, the middle cathode separator 300 of the second unit 1200 is stacked at a lower side of the middle cathode separator 300 which is disposed at a lowermost side of the first unit 1100. Also, referring to FIGS. 4 and 5, the middle cathode separator 300 of the second unit 1200 is stacked so that the fuel gas supplying hole 312 is communicated with the fuel gas supplying hole 212, the fuel gas discharging hole 314 is communicated with the fuel gas discharging hole 214, the air supplying hole 322 is communicated with the air supplying hole 222, the air discharging hole 324 is communicated with the air discharging hole 224, the first cathode reformer installing hole 342 is communicated with the first anode reformer installing hole 242, the second cathode reformer installing hole 344 is communicated with the second anode reformer installing hole 244, the first cathode burner installing hole 352 is communicated with the first anode burner installing hole 252, and the second cathode burner installing hole 354 is communicated with the second anode burner installing hole 254.

Referring to FIG. 2, the insulating member 800 is stacked at a lower side of the middle cathode separator 300. Also referring to FIG. 5a, the insulating member 800 is stacked so that the fuel gas supplying hole 812 is communicated with the fuel gas supplying hole 312, the fuel gas discharging hole 814 is communicated with the fuel gas discharging hole 314, the air supplying hole 822 is communicated with the air supplying hole 322, the air discharging hole 824 is communicated with the air discharging hole 324, the first insulating member reformer installing hole 842 is communicated with the first cathode reformer installing hole 342, the second insulating member reformer installing hole 844 is communicated with the second cathode reformer installing hole 344, the first insulating member burner installing hole 852 is communicated with the first cathode burner installing hole 352, and the second insulating member burner installing hole 854 is communicated with the second cathode burner installing hole 354.

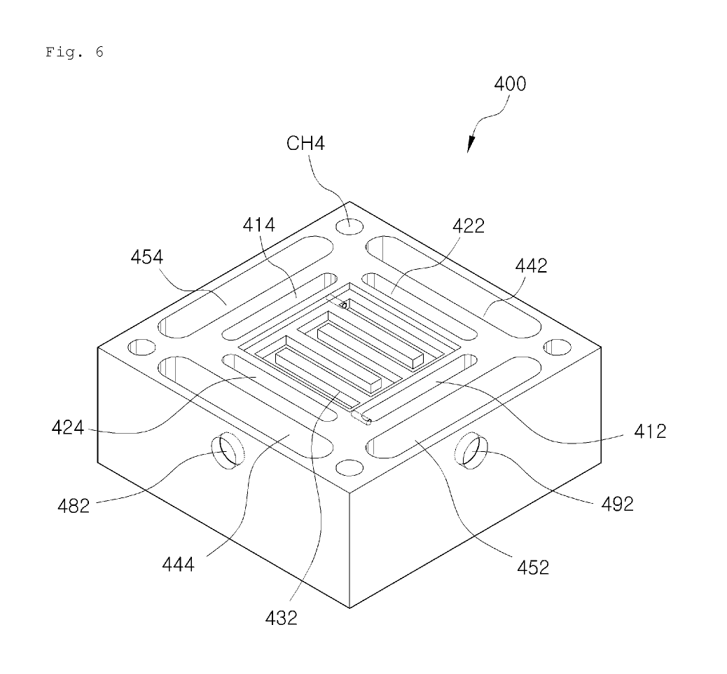

Referring to FIG. 5, the current collector 700 and the unit cell 100 are introduced through a through-hole 810 of the insulating member 800 and stacked at a lower side of the middle cathode separator 300. Meanwhile, the unit cell 100 is attached to an upper surface of the metal support 600 by slurry adhesion and the like, thereby being stacked on the metal support 600. Referring to FIG. 6, the metal support 600 is stacked on an upper side of a fuel channel 432 of a lowermost anode separator 400 described below.

FIG. 6 is a perspective view of the lowermost anode separator 400 according to the first embodiment of the present invention.

Referring to FIG. 6, an upper surface of the lowermost anode separator 400 is formed with a fuel gas supplying groove 412, a fuel gas discharging groove 414, an air supplying groove 422 and an air discharging groove 424. Also, the upper surface of the lowermost anode separator 400 is formed with the fuel channel 432 communicated with the fuel gas supplying groove 412 and the fuel gas discharging groove 414. The fuel channel 432 is formed at a center portion of the lowermost anode separator 400 so that the fuel gas supplying groove 412 is opposed to the fuel gas discharging groove 414 and the air supplying groove 422 is opposed to the air discharging groove 424 with the fuel channel 432 in the center. Referring to FIGS. 5 and 2, the fuel gas supplying groove 412 is communicated with the fuel gas supplying hole 312 through the insulating member 800, the fuel gas discharging groove 414 is communicated with the fuel gas discharging hole 314 through the insulating member 800, the air supplying groove 422 is communicated with the air supplying hole 322 through the insulating member 800, and the air discharging groove 424 is communicated with the air discharging hole 324 through the insulating member 800.

Referring to FIG. 6, the upper surface of the lowermost anode separator 400 is also formed with a first anode reformer installing groove 442 for installing a first reformer (not shown), a second anode reformer installing groove 444 for installing a second reformer, a first anode burner installing groove 452 for installing a first after burner (not shown) and a second anode burner installing groove 454 for installing a second after burner (not shown) The first anode reformer installing groove 442 is opposed to the second anode reformer installing groove 444 and the first anode burner installing groove 452 is opposed to the second anode burner installing groove 454 with the fuel channel 432 in the center. Referring to FIGS. 5 and 2, the first anode reformer installing groove 442 is communicated with the first cathode reformer installing hole 342 through the insulating member 800, the second anode reformer installing groove 444 is communicated with the second cathode reformer installing hole 344 through the insulating member 800, the first anode burner installing groove 452 is communicated with the first cathode burner installing hole 352 through the insulating member 800, and the second anode burner installing groove 454 is communicated with the second cathode burner installing hole 354 through the insulating member 800.

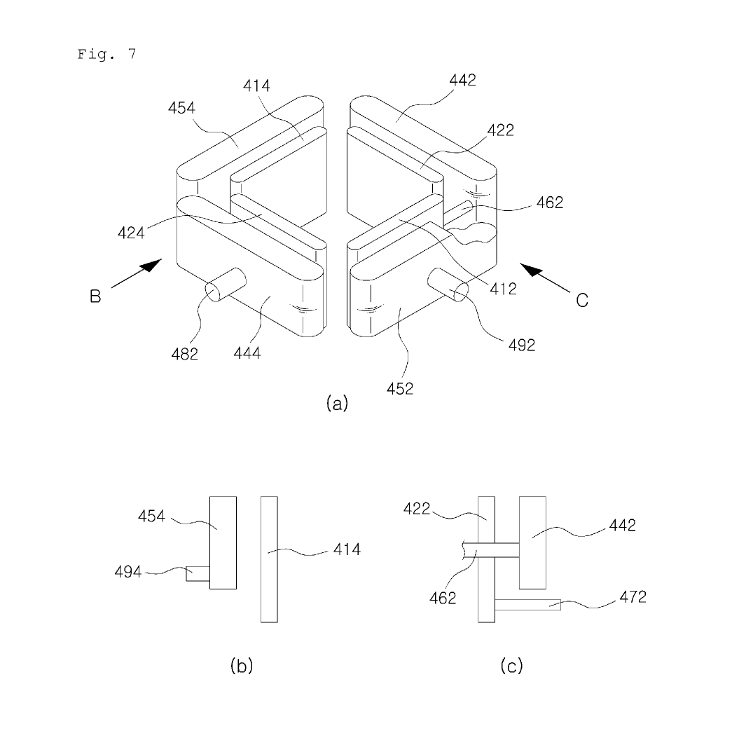

FIG. 7a is a schematic view of a main portion of the lowermost anode separator 400 of FIG. 6, FIG. 7b is a schematic view of the fuel gas discharging groove 414 and the second anode burner installing groove 454 as viewed along an arrow B, and FIG. 7c is a schematic view of the air supplying groove 422 and the first anode reformer installing groove 442 as viewed along an arrow C.

Referring to FIGS. 6 and 7, an air injecting hole 472 (FIG. 7) communicated with the air supplying groove 422 is formed at a side surface of the lowermost anode separator 400. Particularly, referring to FIGS. 7a and 7c, the air supplying groove 422 has a deeper depth than the first anode reformer installing groove 442 so that the air injecting hole 472 is spaced apart to a lower side of the first anode reformer installing groove 442 so as to be communicated with a lower end of the first anode reformer installing groove 442.

Referring to FIGS. 6 and 7a, a fuel gas injecting hole 482 communicated with the second anode reformer installing groove 444 is formed at another side surface of the lowermost anode separator 400, and a first burned gas discharging hole 492 communicated with the first anode burner installing groove 452 is formed at yet another side surface of the lowermost anode separator 400. Meanwhile, referring to FIG. 7b, a second burned gas discharging hole 494 communicated with the second anode burner installing groove 454 is formed at yet another side surface of the lowermost anode separator 400. Referring to FIG. 7a, a fuel gas supply communication hole 462 communicating the first anode reformer installing groove 442 and the fuel gas supplying groove 412 is formed in the lowermost anode separator 400.

Referring to FIG. 3, the third unit 1300 includes a unit cell 100, an uppermost cathode separator 500, a middle anode separator 200, a metal support 600, a current collector 700 and an insulating member 800.

The middle anode separator 200 of the third unit 1300 is stacked on an upper surface of the cathode separator 300 which is placed at an uppermost of the first unit 1100. Referring to FIGS. 4 and 5, the middle anode separator 200 of the third unit 1300 is stacked so that the fuel gas supplying hole 212 is communicated with the fuel gas supplying hole 312, the fuel gas discharging hole 214 is communicated with the fuel gas discharging hole 314, the air supplying hole 222 is communicated with the air supplying hole 322, the air discharging hole 324 is communicated with the air discharging hole 324, the first anode reformer installing hole 242 is communicated with the first cathode reformer installing hole 342, the second anode reformer installing hole 244 is communicated with the second cathode reformer installing hole 344, the first anode burner installing hole 252 is communicated with the first cathode burner installing hole 352, and the second anode burner installing hole 254 is communicated with the second cathode burner installing hole 354.

Referring to FIG. 3, the metal support 600 is stacked on an upper surface of the middle anode separator 200. The metal support 600 is stacked on an upper side of the fuel channel 232, and the unit cell 100 is stacked on the metal support 600. The unit cell 232 is attached to the metal support 600 by slurry adhesion so that the anode 120 is disposed at a lower side.

The current collector 700 is stacked on an upper surface of the unit cell 100, and the uppermost cathode separator 500 is stacked on the current collector 700. Meanwhile, the insulating member 800 is stacked between the middle anode separator 200 and the uppermost cathode separator 500, and a through-hole 810 through which the unit cell 100 and the current collector 700 are introduced is formed at a center portion of the insulating member 800.

Referring to FIGS. 3 and 4, the insulating member 800 is stacked so that the fuel gas supplying hole 812 is communicated with the fuel gas supplying hole 212, the fuel gas discharging hole 814 is communicated with the fuel gas discharging hole 214, the air supplying hole 822 is communicated with the air supplying hole 322, the air discharging hole 824 is communicated with the air discharging hole 224, the first insulating member reformer installing hole 842 is communicated with the first anode reformer installing hole 242, the second insulating member reformer installing hole 844 is communicated with the second anode reformer installing hole 244, the first insulating member burner installing hole 852 is communicated with the first anode burner installing hole 252, and the second insulating member burner installing hole 854 is communicated with the second anode burner installing hole 254.

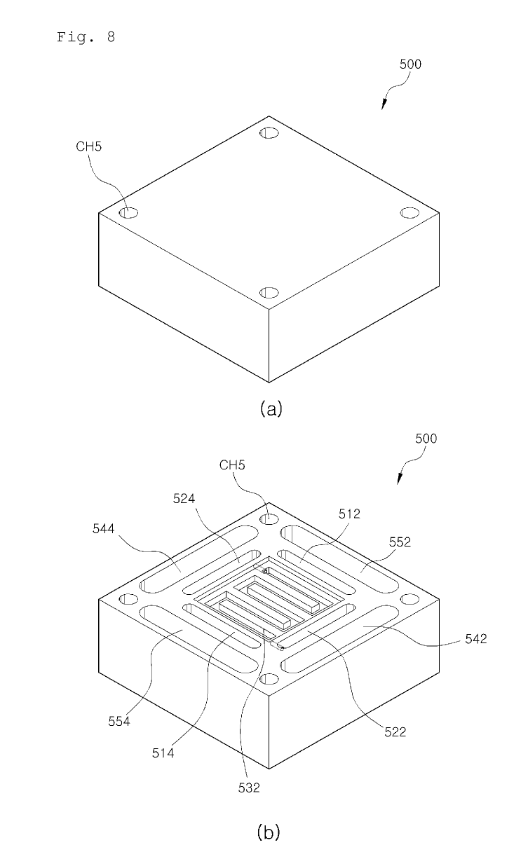

FIG. 8a is a perspective view of the uppermost cathode separator 500 of FIG. 3, and FIG. 8b is a lower perspective view of the uppermost cathode separator 500 of FIG. 3.

Referring to FIG. 8b, a fuel gas supplying groove 512, a fuel gas discharging groove 514, an air supplying groove 522 and an air discharging groove 524 are formed at a lower surface of the uppermost cathode separator 500, and also an air channel 532 communicated with the fuel gas supplying groove 512 and the fuel gas discharging groove 514 is formed at the lower surface of the uppermost cathode separator 500. The air channel 532 is formed at a center portion of the uppermost cathode separator 500 so that the fuel gas supplying groove 512 is opposed to the fuel gas discharging groove 514 and the air supplying groove 522 is opposed to the air discharging groove 524 with the fuel channel 532 in the center. Referring to FIGS. 4 and 3, the fuel gas supplying groove 512 is communicated with the fuel gas supplying hole 212 through the insulating member 800, the fuel gas discharging groove 514 is communicated with the fuel gas discharging hole 214 through the insulating member 800, the air supplying groove 522 is communicated with the air supplying hole 222 through the insulating member 800, and the air discharging groove 524 is communicated with the air discharging hole 224 through the insulating member 800.

Referring to FIG. 8b, the upper surface of the uppermost cathode separator 500 is also formed with a first cathode reformer installing groove 542 for installing a first reformer (not shown), a second cathode reformer installing groove 544 for installing a second reformer, a first cathode burner installing groove 552 for installing a first after burner (not shown) and a second cathode burner installing groove 554 for installing a second after burner (not shown). The first cathode reformer installing groove 542 is opposed to the second cathode reformer installing groove 544 and the first cathode burner installing groove 552 is opposed to the second cathode burner installing groove 554 with the fuel channel 532 in the center. Referring to FIGS. 4 and 3, the first cathode reformer installing groove 542 is communicated with the first anode reformer installing hole 242 through the insulating member 800, the second cathode reformer installing groove 544 is communicated with the second anode reformer installing hole 244 through the insulating member 800, the first cathode burner installing groove 552 is communicated with the first anode burner installing hole 252 through the insulating member 800, and the second cathode burner installing groove 554 is communicated with the second anode burner installing hole 254 through the insulating member 800.

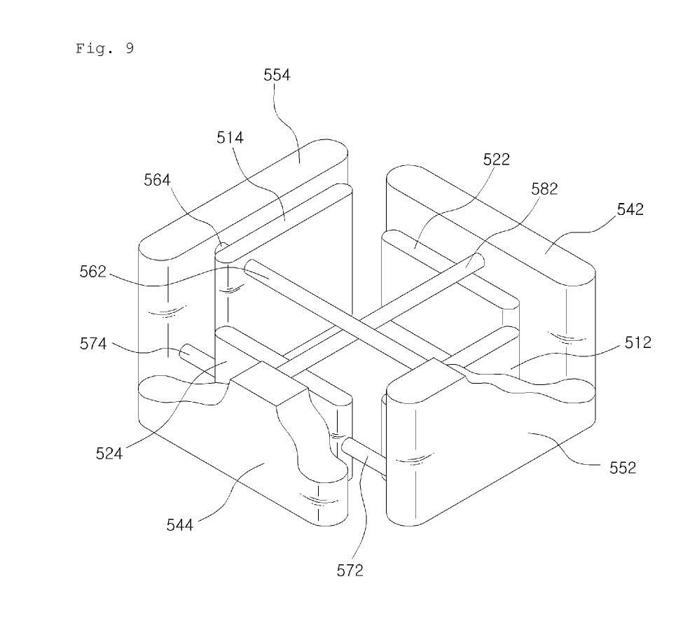

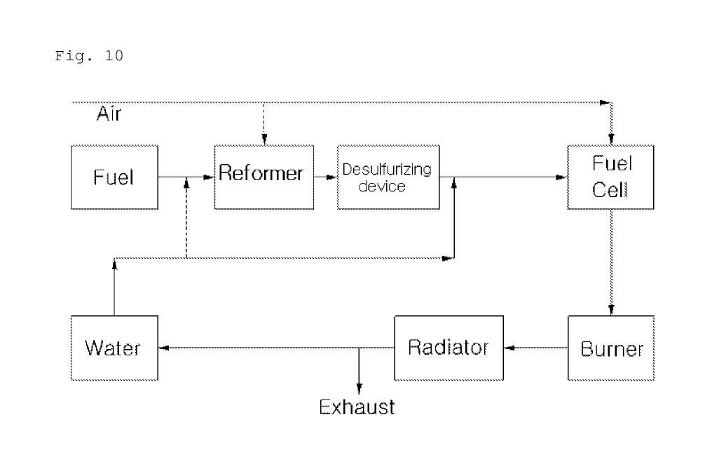

FIG. 9 is a schematic view of a main portion of the uppermost cathode separator 500 of FIG. 8a.

Referring to FIG. 9, the uppermost cathode separator 500 is formed with a fuel gas supply communication hole 562 communicating the first cathode burner installing groove 552 and the fuel gas discharging groove 514. The fuel gas supply communication hole 562 is spaced apart to an upper side of the fuel gas supplying groove 512 so as to be communicated with an upper end of the fuel gas discharging groove 514 and an upper end of the first cathode burner installing groove 552. To this end, the fuel gas discharging groove 514 and the first cathode burner installing groove 552 have a deeper depth than the fuel gas supplying groove 512. In addition, the uppermost cathode separator 500 is formed with a second fuel gas discharge communication hole 564 communicating the fuel gas discharging groove 514 and the second cathode burner installing groove 554.

Referring to FIG. 9, the uppermost cathode separator 500 is also formed with a first air discharge communication hole 572 communicating the air discharging groove 524 and the first cathode burner installing groove 552. Further, the uppermost cathode separator 500 is formed with a second air discharge communication hole 574 communicating the air discharging groove 524 and the second cathode burner installing groove 554.

Referring to FIG. 9, the uppermost cathode separator 500 is also formed with a reformer installing groove communication hole 582 communicating the second cathode reformer installing groove 544 and the first cathode reformer installing groove 542. The reformer installing groove communication hole 582 is spaced apart to an upper side of the air supplying groove 522 and the air discharging groove 524 so as to be communicated with an upper end of the first cathode reformer installing groove 542 and an upper end of the second cathode reformer installing groove 544. To this end, the first cathode reformer installing groove 542 and the second cathode reformer installing groove 544 have a deeper depth than the air supplying groove 522 and the air discharging groove 524.

Although not shown, if the second unit 1200, the first unit 1100 and the third unit 1300 are stacked in turn, fuel gas supplying paths of the second unit 1200, the first unit 1100 and the third unit 1300 are communicated in turn from a lower side to an upper side, and thus a fuel gas supplying passage is formed.

Referring to FIGS. 2, 6 and 5, the fuel gas supplying path of the second unit is formed by communicating the fuel gas supplying groove 412, the fuel gas supplying hole 812 and the fuel gas supplying hole 312 in turn.

Referring to FIGS. 1, 4 and 5, the fuel gas supplying path of the first unit is formed by communicating the fuel gas supplying hole 212, the fuel gas supplying hole 812 and the fuel gas supplying hole 312 in turn.

Referring to FIGS. 3, 4 and 9, the fuel gas supplying path of the third unit is formed by communicating the fuel gas supplying hole 212, the fuel gas supplying hole 812 and the fuel gas supplying groove 512 in turn.

In the same way, if the second unit 1200, the first unit 1100 and the third unit 1300 are stacked in turn, fuel gas discharging paths of the second unit 1200, the first unit 1100 and the third unit 1300 are communicated in turn from a lower side to an upper side, and thus a fuel gas discharging passage is formed. The construction way of the fuel gas discharging passage is the same as the fuel gas supplying passage, and thus the detailed description thereof will be omitted.

In the same way, if the second unit 1200, the first unit 1100 and the third unit 1300 are stacked in turn, air supplying paths of the second unit 1200, the first unit 1100 and the third unit 1300 are communicated in turn from a lower side to an upper side, and thus an air supplying passage is formed. The construction way of the air supplying passage is the same as the fuel gas supplying passage, and thus the detailed description thereof will be omitted.

In the same way, if the second unit 1200, the first unit 1100 and the third unit 1300 are stacked in turn, air discharging paths of the second unit 1200, the first unit 1100 and the third unit 1300 are communicated in turn from a lower side to an upper side, and thus an air discharging passage is formed. The construction way of the air discharging passage is the same as the fuel gas supplying passage, and thus the detailed description thereof will be omitted.

If the second unit 1200, the first unit 1100 and the third unit 1300 are stacked in turn, first reformer installing areas of the second unit 1200, the first unit 1100 and the third unit 1300 are communicated in turn from a lower side to an upper side, and thus a first reformer installing region is formed.

Referring to FIGS. 2, 6 and 5, the first reformer installing area of the second unit 1200 is formed by communicating the first anode reformer installing groove 442, the first insulating member reformer installing hole 842 and the first cathode reformer installing hole 342 in turn.

Referring to FIGS. 1, 4 and 5, the first reformer installing area of the first unit 1100 is formed by communicating the first anode reformer installing groove 242, the first insulating member reformer installing hole 842 and the first cathode reformer installing hole 342 in turn.

Referring to FIGS. 3, 4 and 9, the first reformer installing area of the third unit 1300 is formed by communicating the first anode reformer installing groove 242, the first insulating member reformer installing hole 842 and the first cathode reformer installing hole 542 in turn.

In the same way, if the second unit 1200, the first unit 1100 and the third unit 1300 are stacked in turn, second reformer installing areas of the second unit 1200, the first unit 1100 and the third unit 1300 are communicated in turn from a lower side to an upper side, and thus a second reformer installing region is formed. The construction way of the second reformer installing region is the same as the first reformer installing region, and thus the detailed description thereof will be omitted.

In the same way, if the second unit 1200, the first unit 1100 and the third unit 1300 are stacked in turn, first burner installing areas of the second unit 1200, the first unit 1100 and the third unit 1300 are communicated in turn from a lower side to an upper side, and thus a first burner installing region is formed. The construction way of the first burner installing region is the same as the first reformer installing region, and thus the detailed description thereof will be omitted.

In the same way, if the second unit 1200, the first unit 1100 and the third unit 1300 are stacked in turn, second burner installing areas of the second unit 1200, the first unit 1100 and the third unit 1300 are communicated in turn from a lower side to an upper side, and thus a second burner installing region is formed. The construction way of the second burner installing region is the same as the first reformer installing region, and thus the detailed description thereof will be omitted.

Meanwhile, the first reformer (not shown) is installed in the first reformer installing region, the second reformer (not shown) is installed in the second reformer installing region, the first after burner (not shown) is installed in the first burner installing region, and the second after burner (not shown) is installed in the second burner installing region.

Hereinafter, a flow path of the fuel gas injected through the fuel gas injecting hole 482 shown in FIGS. 6 and 7a will be described.

Referring to FIGS. 6 and 7a, the fuel gas injected through the fuel gas injecting hole 482 is passed through the second after burner installed in the second burner installing region. Referring to FIG. 9, the fuel gas reformed by passing through the second after burner is passed through the reformer installing groove communication hole 582 and the first after burner (not shown) installed in the first burner installing region. Referring to FIG. 7a, the fuel gas reformed by passing through the first after burner is introduced into the fuel gas supplying passage through the fuel gas supply communication hole 462. Referring to FIGS. 6 and 4, the fuel gas introduced into the fuel gas supplying passage is flowed to the fuel channels 232 and 432, and then a chemical reaction occurs through the unit cell 100. Non-reacted fuel gas and a by-product of the chemical reaction are introduced into the fuel gas discharging passage communicated with each fuel channel 232, 432. Referring to FIG. 9, the fuel gas discharging passage is connected to the second burner installing region through the fuel gas supply communication hole 562, and connected to the second burner installing region through the second fuel gas discharge communication hole 564. Therefore, the non-reacted fuel gas and the by-product of the chemical reaction are burned by the first and second after burners. Referring to FIGS. 7a and 7b, the fuel gas burned by the first and second after burners is discharged through the first burned gas discharging hole 492 and the second burned gas discharging hole 494.

Now, a flow path of the air injected through the air injecting hole 472 shown in FIG. 7c will be described.

Referring to FIG. 7c, the air injected through the air injecting hole 472 is introduced into the air supplying passage. Referring to FIGS. 5b and 8, the air introduced into the air supplying passage is flowed to the air channels 332 and 532, and then the chemical reaction occurs through the unit cell 100. Non-reacted air and a by-product of the chemical reaction are introduced into the air discharging passage communicated with each air channel 332, 532. Referring to FIG. 9, the air discharging passage is connected to the first burner installing region through the first air discharge communication hole 572, and connected to the second burner installing region through the second air discharge communication hole 574. Therefore, the non-reacted air and the by-product of the chemical reaction are burned by the first and second after burners. Referring to FIGS. 7a and 7b, the gas burned by the first and second after burners is discharged through the first burned gas discharging hole 492 and the second burned gas discharging hole 494.

According to the present invention, at least one of the second reformer installing region and the second burner installing region may be not formed. If the second reformer installing region is not formed, the fuel gas injecting hole 482 may be formed at a side surface of the uppermost cathode separator 500 so as to be communicated with the first reformer installing region.

### Second Embodiment

A second embodiment is related to a SOFC system integrated with a reformer according to the present invention.

In the embodiment, another current collector (hereinafter, anode current collector) instead of the metal support 600 is stacked on the lower surface of the unit cell 100.

That is, instead of each metal support 600 of the second unit 1200, the first unit 1100 and the third unit 1300, the anode current collector is stacked.

The other conditions are the same as those in the first embodiment, and thus the description thereof will be omitted.

### Third Embodiment

A third embodiment is related to a SOFC system integrated with a reformer according to the present invention, particularly, to a SOFC having the middle anode separator 200 and the middle cathode separator 300.

The middle anode separator 200 and the middle cathode separator 300 are the same as those in the first embodiment, and thus the description thereof will be omitted.

### INDUSTRIAL APPLICABILITY

According to the present invention, since the reformer and the after burner are integrally formed at the separator of the SOFC, it is possible to simplify the SOFC system and perform the heat management at the same time. In other words, since the reformer and the after burner are integrally provided at the separator of the SOFC, the system can be simplified. Further, since the SOFC system is an external reforming type that the reforming reaction is occurred separately from the electrochemical reaction of the SOFC, it is possible to stably operate the system. Further, since the non-reacted fuel gas is burned and collected by using the after burner, the system has a very high efficiency.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A solid oxide fuel cell system integrated with reformer, comprising:
a unit cell having an electrolyte layer, an anode coupled to a lower surface of the electrolyte layer and a cathode coupled to an upper surface of the electrolyte layer;
a middle anode separator formed with a fuel gas supplying hole, a fuel gas discharging hole, an air supplying hole and an air discharging hole that pass through the middle anode separator, and also formed with a fuel channel connected to the fuel gas supplying hole and the fuel gas discharging hole, which is formed at an upper surface of the middle anode separator;
a middle cathode separator formed with a fuel gas supplying hole, a fuel gas discharging hole, an air supplying hole and an air discharging hole that pass through the middle cathode separator, and also formed with an air channel connected to the air supplying hole and the air discharging hole, which is formed at a lower surface of the middle cathode separator;
a lowermost anode separator formed with a fuel gas supplying groove, a fuel gas discharging groove, an air supplying groove, an air discharging groove, a fuel channel connected with the fuel gas supplying groove and the fuel gas discharging groove, a first anode reformer installing groove communicated with the first cathode reformer installing hole so as to install a reformer, and a first anode burner installing groove communicated with the first cathode burner installing hole so as to install an after burner, which are formed at an upper surface of the lowermost anode separator, and also formed with a fuel gas supply communication hole communicating the first anode reformer installing groove and the fuel gas supplying groove; and
an uppermost cathode separator formed with a fuel gas supplying groove, a fuel gas discharging groove, an air supplying groove, an air discharging groove, an air channel connected with the fuel gas supplying groove and the fuel gas discharging groove, a first cathode reformer installing groove communicated with the first anode reformer installing hole so as to install the reformer, and a first cathode burner installing groove communicated with the first anode burner installing hole so as to install the after burner, which are formed at a lower surface of the uppermost cathode separator, and also formed with a first air discharge communication hole communicating the air discharging groove and the first cathode burner installing groove,
wherein the middle anode separator is formed with a first anode reformer installing hole for installing the reformer, and a first anode burner installing hole for installing the after burner, which pass through the middle anode separator, and
the middle cathode separator is formed with a first cathode reformer installing hole communicated with the first anode reformer installing hole so as to install the reformer, and a first cathode burner installing hole communicated with the first anode reformer installing hole so as to install the after burner, which pass through the middle cathode separator.

2. The solid oxide fuel cell system integrated with reformer as set forth in claim 1, wherein the middle anode separator is formed with a second anode reformer installing hole for installing the reformer and a second anode burner installing hole for installing the after burner, which pass through the middle anode separator,
the middle cathode separator is formed with a cathode reformer installing hole communicated with the second anode reformer installing hole so as to install the reformer and a second cathode burner installing hole communicated with the second anode reformer installing hole so as to install the after burner, which pass through the middle cathode separator,
the lowermost anode separator is formed with a second anode reformer installing groove communicated with the second cathode reformer installing hole so as to installing the reformer and a second anode burner installing groove communicated with the second cathode burner installing hole so as to installing the after burner, which are formed at an upper surface of the lowermost anode separator, and
the uppermost cathode separator is formed with a second cathode reformer installing groove communicated with the second anode reformer installing hole so as to installing the reformer and a second cathode burner installing groove communicated with the second anode burner installing hole so as to installing the after burner, which are formed at an upper surface of the uppermost cathode separator, and also formed with a reformer installing groove communication hole communicating the second cathode reformer installing groove and the first cathode reformer installing groove, a second fuel gas discharge communication hole communicating the fuel gas discharging groove and the second cathode burner installing groove and a second air discharge communication hole communicating the air discharging groove and the second cathode burner installing groove.

3. The solid oxide fuel cell system integrated with reformer as set forth in claim 2, wherein an air injecting hole communicated with the air supplying groove, a fuel gas injecting hole communicated with the second anode reformer installing groove, a first burned gas discharging hole communicated with the first anode burner installing groove and a second burned gas discharging hole communicated with the second anode burner installing groove are formed at a side surface of the lowermost anode separator.

4. The solid oxide fuel cell system integrated with reformer as set forth in claim 3, wherein the air supplying groove is opposed to the second anode reformer installing groove, the first anode burner installing groove is opposed to the second anode burner installing groove, the air supplying groove is opposed to the air discharging groove and the fuel gas supplying groove is opposed to the fuel gas discharging groove with the fuel channel in the center, and
the air supplying groove has a deeper depth than the first anode reformer installing groove so that the air injecting hole is spaced apart to a lower side of the first anode reformer installing groove so as to be communicated with a lower end of the first anode reformer installing groove.

5. The solid oxide fuel cell system integrated with reformer as set forth in claim 4, wherein the fuel gas discharging groove and the first cathode burner installing groove have a deeper depth than the fuel gas supplying groove so that the fuel gas supply communication hole is spaced apart to an upper side of the fuel gas supplying groove so as to be communicated with an upper end of the fuel gas discharging groove and an upper end of the first cathode burner installing groove, and
the first cathode reformer installing groove and the second cathode reformer installing groove have a deeper depth than the air supplying groove and the air discharging groove so that the reformer installing groove communication hole is spaced apart to an upper side of the air supplying groove and the air discharging groove so as to be communicated with an upper end of the first cathode reformer installing groove and an upper end of the second cathode reformer installing groove.

6. The solid oxide fuel cell system integrated with reformer as set forth in claim 5, wherein a metal support is stacked on a lower surface of the unit cell, and an anode current collector is stacked on an upper surface thereof.

7. The solid oxide fuel cell system integrated with reformer as set forth in claims 5, wherein an anode current collector is stacked on a lower surface of the unit cell, and a cathode current collector is stacked on an upper surface thereof.

8. A solid oxide fuel cell system integrated with reformer, comprising:
a unit cell having an electrolyte layer, an anode coupled to a lower surface of the electrolyte layer and a cathode coupled to an upper surface of the electrolyte layer;
a middle anode separator formed with a fuel gas supplying hole, a fuel gas discharging hole, an air supplying hole and an air discharging hole that pass through the middle anode separator, and also formed with a fuel channel connected to the fuel gas supplying hole and the fuel gas discharging hole, which is formed at an upper surface of the middle anode separator;
a middle cathode separator formed with a fuel gas supplying hole, a fuel gas discharging hole, an air supplying hole and an air discharging hole that pass through the middle cathode separator, and also formed with an air channel connected to the air supplying hole and the air discharging hole, which is formed at a lower surface of the middle cathode separator,
wherein the middle anode separator is formed with a first anode reformer installing hole for installing a reformer, and a first anode burner installing hole for installing an after burner, which pass through the middle anode separator, and
the middle cathode separator is formed with a first cathode reformer installing hole communicated with the first anode reformer installing hole so as to install the reformer, and a first cathode burner installing hole communicated with the first anode reformer installing hole so as to install the after burner, which pass through the middle cathode separator.
